(19) United States
(12) Patent Application Publication
(10) Pub. No.: US 2024/0257281 A1
(43) Pub. Date: Aug. 1, 2024

(54) SYSTEM AND METHOD FOR PREDICTING INTELLECTUAL PROPERTY INFRINGEMENT

(71) Applicant: Walmart Apollo, LLC, Bentonville, AR (US)

(72) Inventors: Arup Kumar Das, Bengaluru (IN); Rajat Gupta, Hazipura Shamli (IN); Raviteja Uppalapati, San Francisco, CA (US); Samrat Kokkula, Hyderabad (IN)

(73) Assignee: Walmart Apollo, LLC, Bentonville, AR (US)

(21) Appl. No.: 18/427,436

(22) Filed: Jan. 30, 2024

Related U.S. Application Data
(60) Provisional application No. 63/441,958, filed on Jan. 30, 2023.

(51) Int. Cl. G06Q 50/18

(52) U.S. Cl. CPC G06Q 50/184

(57) ABSTRACT

A computer-implemented method including determining a feature-embedding vector for a listing item based on textual feature data and imagery feature data for the listing item. The method also can include determining, via a machine learning module, an intellectual property infringement prediction associated with a genuine item based on a feature-embedding vector for the genuine item and the feature-embedding vector for the listing item. Furthermore, the method can include upon determining that the intellectual property infringement prediction is positive, causing a take-down of the listing item from a retailer platform. Other embodiments are described.

### CROSS-REFERENCE TO RELATED APPLICATIONS

This application claims the benefit of U.S. Provisional Application No. 63/441,958, filed Jan. 30, 2023. U.S. patent Application No. 63/441,958 is incorporated herein by reference in its entirety.

### TECHNICAL FIELD

This disclosure relates generally to predicting intellectual property infringement.

### BACKGROUND

Online retailers and those that offer online marketplaces for sellers sometimes receive requests to takedown items for sale due to alleged infringement of intellectual property rights. Conventional approaches evaluate such requests manually once received, and valid claims result in the items being blocked from sale, and, in some cases, termination of the seller from participating in the online marketplace.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for determining whether a listing item is likely to infringe an intellectual property of a third party, according to an embodiment; and

FIG. 4 illustrates a flow chart for a method 400 of predicting intellectual property infringement, according to an embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, ten seconds, thirty seconds, one minute, five minutes, ten minutes, etc.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

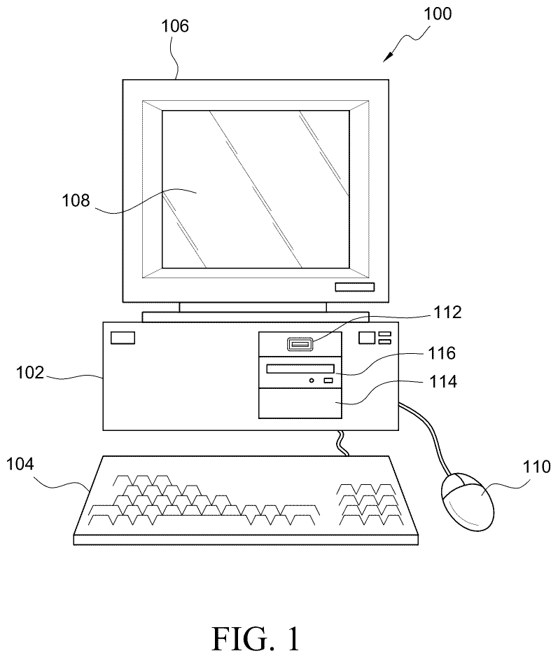

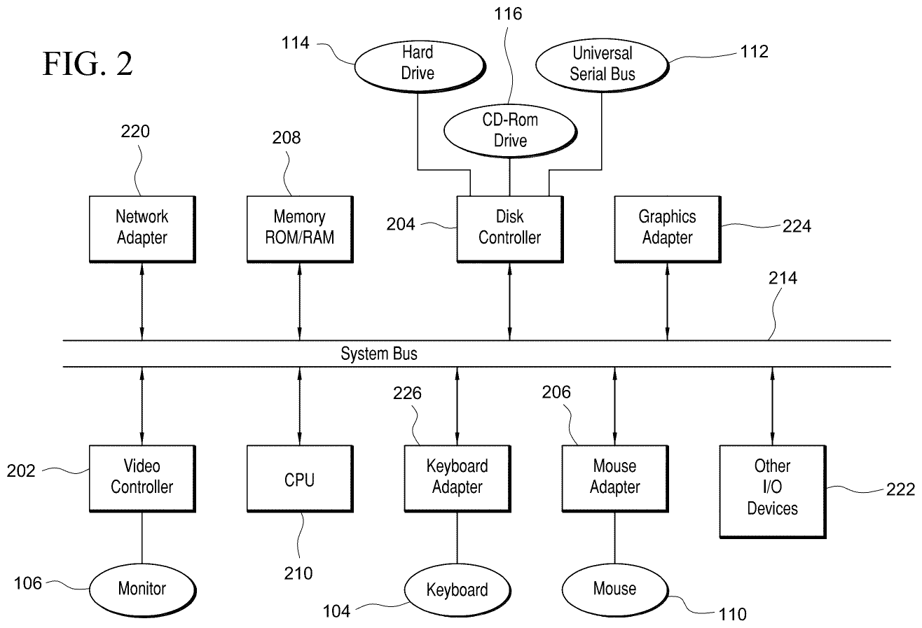

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can includes one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

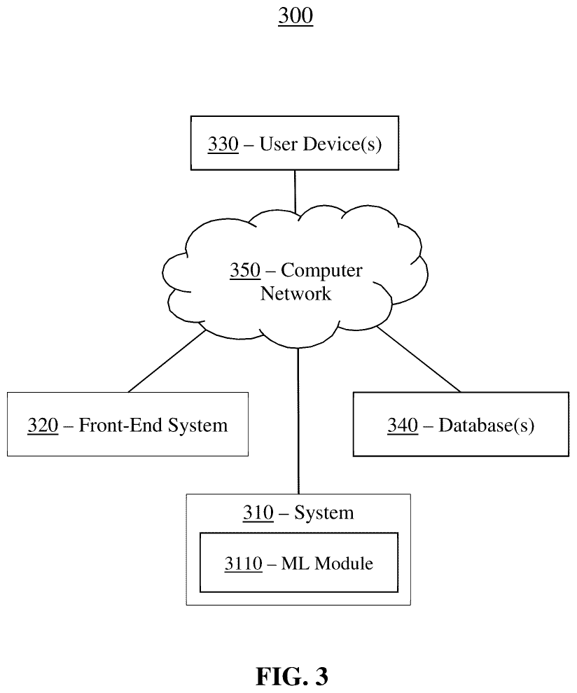

Turning ahead in the drawings, FIG. 3 illustrates a block diagram of a system 300 that can be employed for determining whether a listing item is likely to infringe an intellectual property of a third party, according to an embodiment. In various embodiments, the listing item can be a product listing by a vendor on an e-commerce platform. The third party can be an owner of any proprietary intellectual (IP) property rights (e.g., copyright, trademarks, designs, etc.). A listing item can be infringing by incorporating the subject of an IP right, entirely or in part, in the listing item's textual and/or imagery features without the owner's authorization.

System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. System 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein. In many embodiments, operators and/or administrators of system 300 can manage system 300, the processor(s) of system 300, and/or the memory storage unit(s) of system 300 using the input device(s) and/or display device(s) of system 300, or portions thereof in each case.

In many embodiments, system 300 can include a system 310, a front-end system 320, a user device(s) 330, and/or a database(s) 340. System 310 further can include one or more elements, modules, or systems, such as an ML module 3110 trained to perform various procedures, processes, and/or activities of system 300 and/or system 310.

System 310, front-end system 320, user device(s) 330, and/or ML module 3110 can each be a computer system, such as computer system 100 (FIG. 1), as described above, and can each be a single computer, a single server, or a cluster or collection of computers or servers, or a cloud of computers or servers. In another embodiment, a single computer system can host system 310, front-end system 320, user device(s) 330, and/or ML module 3110. Additional details regarding system 310, front-end system 320, user device(s) 330, and ML module 3110 are described herein.

In some embodiments, system 310 can be in data communication with front-end system 320 and/or user device(s) 330, using a computer network (e.g., computer network 350), such as the Internet and/or an internal network that is not open to the public. In a number of embodiments, front-end system 320 can host one or more websites and/or mobile application servers that interface with an application (e.g., a mobile application, a web browser, or a chat application) on a computer device (e.g., user device(s) 330) for a consumer or a vendor. In other examples, front-end system 320 further can support back-office applications, including receiving inputs from user device(s) 330, managing orders, item listings, inventory, and/or supply, and/or processing payments, etc.

Meanwhile, in many embodiments, system 310 also can be configured to communicate with and/or include a database(s) 340. In some embodiments, database(s) 340 can include a product catalog of a retailer that contains information about products, items, vendors, or SKUs (stock keeping units), for example, among other data as described herein. In another example, database(s) 340 further can include training data (e.g., genuine items, labeled (positive) and unlabeled (positive or negative) training items that are synthesized or real, etc.) and/or hyper-parameters for training and/or configuring system 310 and/or ML module 3110.

In a number of embodiments, database(s) 340 can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more data sources, that particular database can be stored on a single memory storage unit or the contents of that particular database can be spread across multiple ones of the memory storage units storing the one or more databases, depending on the size of the particular database and/or the storage capacity of the memory storage units. In similar or different embodiments, the one or more data sources can each be a computer system, such as computer system 100 (FIG. 1), as described above, and can each be a single computer, a single server, or a cluster or collection of computers or servers, or a cloud of computers or servers.

Database(s) 340 can include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

In many embodiments, communication between system 310, front-end system 320, user device(s) 330, and/or database(s) 340 can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc.

The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, system 310 can determine a feature-embedding vector for a listing item based on textual feature data and imagery feature data for the listing item. System 310 can determine the feature-embedding by: (a) extracting one or more textual embeddings from the textual feature data for the listing item; (b) extracting one or more imagery embeddings from the imagery feature data for the listing item; and (c) generating the feature-embedding vector based on the one or more textual embeddings and the one or more imagery embeddings. System 310 can extract and encode the textual feature data into the one or more textual embeddings by any suitable embedding techniques (e.g., SiameseNet, sBERT, BM25, TF-IDF, word2vec, GloVe, etc.). System 310 further can extract and encode the imagery feature data into the one or more imagery embeddings by any suitable embedding techniques (e.g., CLIP, VGG-16, ResNet50, Inceptionv3, EfficientNet, ViT, etc.). Moreover, the feature-embedding vector can be generated by combining the one or more textual embeddings and the one or more imagery embeddings into a single vector.

In a number of embodiments, system 310 further can determine, via a machine learning module (e.g., ML module 3110), an intellectual property (IP) infringement prediction associated with a genuine item based on a feature-embedding vector for the genuine item and the feature-embedding vector for the listing item. Upon determining that the IP infringement prediction is positive, system 310 further can cause a take-down of the listing item from a retailer platform (e.g., front-end system 320). The take-down can cause the listing item and/or any associated information (e.g., thumbnails, hyperlinks, etc.) to be temporarily or permanently disabled or hidden from being transmitted to, displayed on, and/or searched by any consumer devices (e.g., user device(s) 330). The take-down further can cause a suspension or cancellation of any pending orders of the product for the listing item associated with the positive infringement prediction. In some embodiments, system 310 can determine the intellectual property infringement prediction when the listing item is created, and the take-down can cause the listing item to remain unpublished.

In many embodiments, the take-down can be performed automatically by system 310 or the retailer platform (e.g., front-end system 320) when the retailer platform receives a notice about the positive IP infringement prediction (e.g., a message from system 310, a flag set for the listing item in database(s) 340, or a remote function call, etc.). In certain embodiments, system 310 and/or front-end system 320 also can inform a system administrator and/or the vendor for the listing item about the take-down and optionally, a procedure for appeal.

The machine learning module (e.g., ML module 3110) can include any suitable algorithms, models, modules, and/or systems, such as one-class classifier, density-based clustering, centroid-based clustering, Positive-Unlabeled (PU) learning, HDBSCAN clustering, etc. In many embodiments, system 310 further can train or re-train the machine learning module (e.g., ML module 3110) to predict whether a first item likely infringes IP rights in a second item based on the respective feature-embedding vectors. The IP rights likely being infringed can be text-and/or image-based. In several embodiments, the machine learning module (e.g., ML module 3110) can be trained based on a single training dataset comprising respective training items of each intellectual-property-infringed brand of multiple brands. For example, the single training dataset can include genuine items of multiple brands (e.g., NIKE® by Nike, Inc. of Beaverton, Oregon, United States of America, DYSON® by Dyson Technology Limited of Malmesbury, Wiltshire, United Kingdom, TEETURTLE® by Tee Turtle, LLC of Hazelwood Missouri, United States of America, GUND® by Spin Master, Inc. of Williamsville, New York, United States of America, ADIDAS® by Adidas AG of Herzogenaurach, Germany, etc.). The multiple brands can include brands owned by multiple owners for similar or different products (e.g., stuffed toys, running shoes, and electric appliances, etc.). In similar or different embodiments, the machine learning module (e.g., ML module 3110) can be trained based on more than one training datasets, and each of the training datasets can include training items for the same or different brands. In various embodiments, integrating data from multiple brands to build a single model or machine learning module can help with maintaining the model, instead of training one model or machine learning module per brand.

Further, in a number of embodiments, system 310 further can train the machine learning module (e.g., ML module 3110) based on a training dataset comprising genuine items, positive training items associated with the genuine items, and unlabeled training items. For instance, the genuine items can include listing items that are authenticated as genuine items or created or uploaded by authorized brand-owner accounts. The positive training items can include those determined to be infringing IP rights in one or more of the genuine items. For examples, the positive training items can be previously reported by brand owners or consumers as counterfeits and labeled as infringing by system 310, front-end system 320, or the system administrator. The unlabeled training items can include listing items that are sampled from the product catalog but have not been reported, labeled, or reviewed. As such, the unlabeled training items can include both unlabeled intellectual-property-infringing (positive) items and unlabeled intellectual-property-noninfringing (negative) items.

In some embodiments, unlabeled items of all of the listing items in a database (e.g., database(s) 340 or a product catalog) can be grouped into different brand training datasets based on the brands that are associated with the unlabeled items and some positive (IP-infringing) items. In many embodiments, the grouping of the unlabeled items into brand training datasets further can be based on the item types (e.g., clothing, footwear, electronics, toys, baby, etc.) associated with the unlabeled items and the respective brands. For example, an unlabeled listing item for a stuffed animal can be assigned to a brand training dataset for a brand (e.g., GUND® or TEETURTLE®, etc.) that is used for plush animals and known to have been IP-infringed by certain positive items. In another example, an unlabeled listing item for a sports apparel can be assigned to a different brand training dataset for a different IP-infringed brand (e.g., NIKE® or ADIDAS®, etc.).

In a number of embodiments, system 310 can sample, from unlabeled items, unlabeled brand training items of a brand training dataset for an intellectual-property-infringed brand (e.g., a NIKE® training dataset for the NIKE® brand or a TEETURTLE® training dataset for the TEETURTLE® brand). The brand training dataset further can include genuine brand items for the intellectual-property-infringed brand (e.g., NIKE® or TEETURTLE®) and positive brand training items associated with the genuine brand items (e.g., training items that are known to have infringed IP rights in the genuine brand items). In certain embodiments, after sampling the unlabeled brand training items, system 310 further can train the machine learning module based at least in part on the brand training dataset.

In many embodiments, the quantity of the unlabeled brand training items sampled by system 310 and included into the brand training dataset can be proportional to the quantity of the positive brand training items. In some embodiments, the quantity of the unlabeled brand training items can be directly proportional to the quantity of the genuine brand items. For example, the brand training dataset can include X genuine brand items, Y positive brand training items, and Z times unlabeled brand training items, wherein Z=a*Y (a can be any suitable positive numbers, such as 3, 5, 7, 10, 12, or 15, etc.).

In many embodiments, each of the listing items in the database (e.g., database(s) 340) can include a respective type of multiple item types (e.g., clothing, footwear, electronics, toys, baby, etc.). Further, each brand can be associated with respective major item types. The criteria for determining the major item types and/or the count of the major item types for a brand can vary according to different embodiments. In some embodiments, the respective major item types for a brand can be determined based on the quantity of the branded items in different types. For example, when the listing items under the NIKE® brand at an e-commerce website (e.g., front-end system 320) have 5 item types: shoes, caps, socks, t-shirts, and bags, and when 50% of these branded items are shoes, 20% are caps, and 18% are t-shirts, the 3 major item types for this brand would be shoes, caps, and t-shirts. In several embodiments, the respective major item for a brand can be determined based on the respective sales volume for each of the branded items in various types. For example, when DYSON®-branded items listed at front-end system 320 have 3 item types: vacuums, purifier fans, and hair dryers, and when their respective sales volumes are 85%, 10%, and 5%, the 2 major item types for this brand would be vacuums and purifier fans.

Further, the count of the major item types for a brand can be fixed or dynamic. In certain embodiments, each brand is associated with a fixed number (e.g., 2, 3, 4, or 5) of respective major item types. In some embodiments, system 310 can determine the major item types based on the accumulative item quantities or accumulative sales volumes. For example, a brand can be associated with 2 major item types when the item quantities of the top 2 item types combined take up more than a threshold (e.g., 65%, 80%, or 90%) of all of the items for this brand.

In a number of embodiments, system 310 further can sample the unlabeled brand training items of a brand training dataset for an IP-infringed brand based on the respective type of each of the unlabeled brand training items. In certain embodiments, system 310 can add to the brand training dataset only the unlabeled brand training items whose respective types are from the major item types for the IP-infringed brand (e.g., the top 2 types of branded items under the NIKE® brand, etc.). That is, the unlabeled brand training items of a brand training dataset can include respective type items (e.g., shoes and caps) that are sampled based at least in part on a respective type of each of the respective type items and the major item types for the IP-infringed brand. In various embodiments, a 10× sample that is sampled uniformly from the top 2 product types stratified for each brand can be used.

In some embodiments, the respective type items of the unlabeled brand training items further can be sampled based on a respective item-type percentage for each type of the major item types for the IP-infringed brand. For examples, when the 2 major item types for an IP-infringed brand (e.g., DYSON®) are vacuums and purifier fans, and when the respective item-type percentages are 75% and 25% between these 2 major item types, the first-type items (vacuums) and the second-type items (purifier fans) sampled can constitute 75% and 25% of the unlabeled brand training items, respectively.

In several embodiments, the respective type items of the unlabeled brand training items for the intellectual-property-infringed brand further can be sampled uniformly from each brand of multiple brands for the unlabeled items, and the multiple brands can include the intellectual-property-infringed brand. In the example above, system 310 further can sample the respective type items of the unlabeled brand training items for the intellectual-property-infringed brand (e.g., vacuums and purifier fans for DYSON®) uniformly from the 3 brands for vacuums (e.g., DYSON®, SHARK® by SharkNinja Operating LLC of Needham, Massachusetts, the United States of America, and BISSELL® by Bissell Inc. of New Grand Rapids, Michigan, the United States of America). When there are 1200 unlabeled brand training items in the brand training dataset for DYSON® in this example, the 1200 unlabeled brand training items would include 900 first-type items (vacuums) and 300 second-type items (purifier fans). Among the 900 first-type items (vacuums), 400 would be sampled from DYSON®-branded items, 400 would be sampled from SHARK®-branded items, and 400 would be sampled from BISSELL®-branded items.

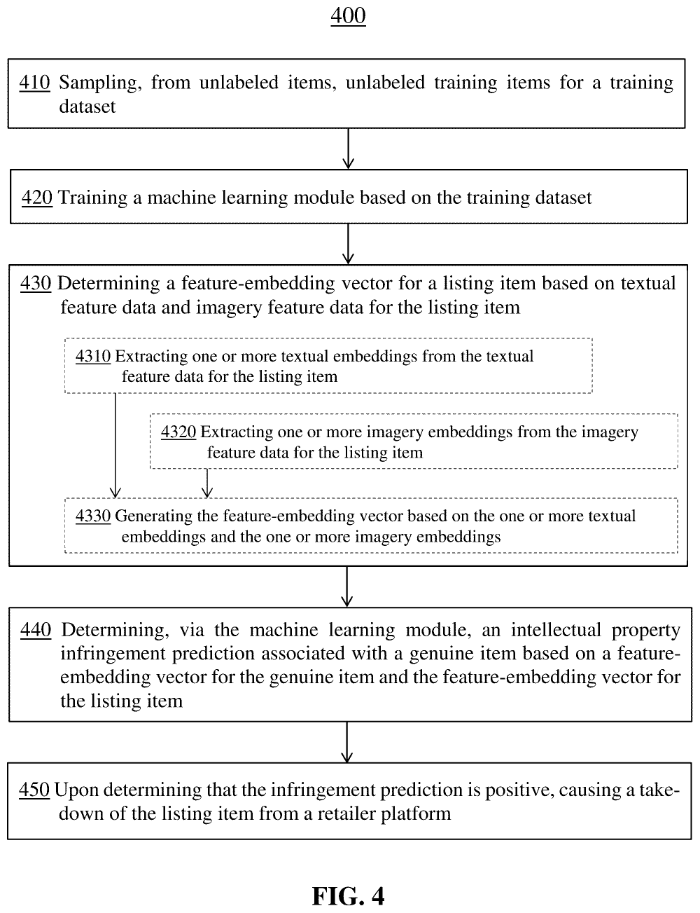

Turning ahead in the drawings, FIG. 4 illustrates a flow chart for a method 400 of predicting intellectual property infringement, according to an embodiment. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any suitable order. In still other embodiments, one or more of the procedures, the processes, and/or the activities of method 400 can be combined or skipped.

In many embodiments, system 300 (FIG. 3) or system 310 (FIG. 3) (including one or more of its elements, modules, and/or systems, such as ML module 3110 (FIG. 3)) can be suitable to perform method 400 and/or one or more of the activities of method 400. In these or other embodiments, one or more of the activities of method 400 can be implemented as one or more computing instructions configured to run at one or more processors and configured to be stored at one or more non-transitory computer readable media. Such non-transitory computer readable media can be part of a computer system such as system 300 (FIG. 3) or system 310 (FIG. 3). The processor(s) can be similar or identical to the processor(s) described above with respect to computer system 100 (FIG. 1).

Referring to FIG. 4, method 400 can include an activity 410 of sampling, from unlabeled items, unlabeled training items for a training dataset. In some embodiments, the training dataset can include a respective brand training dataset for each of intellectual-property-infringed brands. The training dataset can include genuine items for the intellectual-property-infringed brands, positive training items (e.g., IP-infringing items) associated with the genuine items, and the unlabeled training items sampled according to one or more rules provided above. In many embodiments, the unlabeled training items can be sampled based on the IP-infringed brands, the respective quantity of the positive training items for each IP-infringed brand, the respective major item types for each IP-infringed brand, the respective item-type percentage for each of the respective major item types, and/or the relevant brands.

For example, a training dataset D for an embodiment can be:
D=∪ᵢ₌₁^{N} Dᵢ, wherein:
   N is the count of IP-infringed brands; and
   Dᵢ is the i-th brand training dataset for the i-th IP-infringed brand:
      Di=GᵢÅPIᵢÅUIᵢ, wherein:
         Gᵢincludes Xᵢ genuine brand items for the i-th IP-infringed brand, wherein: Xᵢ>0; Gᵢ is associated with 2 (or any suitable number) major item types, T_{i,1}and T_{i,2}, for the i-th IP-infringed brand; the respective item-type percentage for T_{i,1} between T_{i,1}and T_{i,2}is S_{i,1} ; the respective item-type percentage for T_{i,2} between T_{i,1}and T_{i,2}is S_{i,2} ; and S_{i,1}+S_{i,2}=1;
         PIᵢincludes Yᵢ positive brand training items for the i-th IP-infringed brand; and
         UIᵢincludes Zᵢ unlabeled brand training items for the i-th IP-infringed brand, wherein: Zᵢis directionally proportional to Yᵢ(e.g., Zᵢ=10* Yᵢ); and UIᵢ=UI_{i,T}_{_{i,1}}ÅUI_{i,T}_{_{i,2}}, wherein: UI_{i,T}_{_{i,1}} includes S_{i,2}* Zᵢ unlabeled brand items of the respective type T₁, sampled uniformly from M_{T}_{_{i,1}} brands; M_{T}_{_{i,1}} is the count of brands for item type T_{i,1}; UI_{i,T}_{_{i,2}} includes S_{i,2}* Zᵢ unlabeled brand items of the respective type T_{i,2}, sampled uniformly from M_{T}_{_{i,2}} brands; and M_{T}_{_{i,2}} is the count of brands for item type T_{i,2}.

In many embodiments, method 400 further can include an activity 420 of training a machine learning module (e.g., ML module 3110 (FIG. 3)), based on the training dataset. The machine learning module can include any suitable algorithms, models, modules, and/or systems, such as PU (positive-unlabeled) learning, HDBSCAN (hierarchical density-based spatial clustering applications with noise) clustering, etc. Activities 410 and 420 can be performed periodically in a predefined schedule or triggered manually to retrain the machine learning module to keep the machine learning module up to date.

Still referring to FIG. 4., in a number of embodiments, method 400 further can include an activity 430 of determining a feature-embedding vector for a listing item based on textual feature data and imagery feature data for the listing item. In some embodiments, activity 430 further can include an activity 4310 of extracting one or more textual embeddings from the textual feature data for the listing item based on any suitable text-embedding approaches (e.g., word2vec). Activity 430 also can include an activity 4320 of extracting one or more imagery embeddings from the imagery feature data for the listing item based on any suitable image-embedding approaches (e.g., VGG-16). Further, activity 430 can include an activity 4330 of generating the feature-embedding vector based on the one or more textual embeddings generated in activity 4310 and the one or more imagery embeddings generated in activity 4320.

In many embodiments, method 400 further can include an activity 440 of determining, via the machine learning module (e.g., ML module 3110 (FIG. 3), as trained in activity 430), an intellectual property infringement prediction associated with a genuine item based on a feature-embedding vector for the genuine item and the feature-embedding vector for the listing item. In several embodiments, the intellectual property infringement prediction can be a positive-or negative-answer. In some embodiments, the intellectual property infringement prediction can be a score or possibility that the listing item infringes the intellectual property associated with the genuine item.

In a number of embodiments, method 400 further can include an activity 450 of upon determining that the infringement prediction is positive in activity 440, causing a take-down of the listing item from a retailer platform (e.g., front-end system 320 (FIG. 3)). The take-down can be performed automatically (by system 300, system 310, or front-end system 320 in FIG. 3) or manually after a system administrator is made aware of the potential IP infringement by method 400 and/or system 310 (FIG. 3).

Various embodiments can include a system for determining a conversational context for a conversational input. The system can include one or more processors and one or more non-transitory computer-readable media storing computing instructions that, when run on the one or more processors, cause the one or more processors to perform various operations. The operations can include determining a feature-embedding vector for a listing item based on textual feature data and imagery feature data for the listing item. The operations further can include determining, via a machine learning module, an intellectual property infringement prediction associated with a genuine item based on a feature-embedding vector for the genuine item and the feature-embedding vector for the listing item. In addition, the operations can include upon determining that the intellectual property infringement prediction is positive, causing a take-down of the listing item from a retailer platform.

Various embodiments further include a computer-implemented method that can include determining a feature-embedding vector for a listing item based on textual feature data and imagery feature data for the listing item. The method also can include determining, via a machine learning module, an intellectual property infringement prediction associated with a genuine item based on a feature-embedding vector for the genuine item and the feature-embedding vector for the listing item. The method further can include upon determining that the intellectual property infringement prediction is positive, causing a take-down of the listing item from a retailer platform.

In many embodiments, the techniques described herein can provide a practical application and several technological improvements. The techniques described herein can provide a single machine-learning-based system or method trained to objectively and proactively detect infringements of various intellectual property rights (including multiple brands for different types of products). Further, the techniques disclosed here can detect IP infringements in various features of the listing items, including both texts and images. Moreover, the techniques described herein can provide a simplified sampling rule for collecting unlabeled training items to train the system/method to identify negative (non-IP-infringing) items. These techniques described herein can provide a significant improvement over conventional approaches that rely on either manual reporting IP infringements by IP right holders and/or consumers or systems typically trained to detect IP infringements for a single brand. In addition to providing an automatic detection and prevention of IP infringements, compared to the conventional single-brand approaches, the systems and/or methods disclosed here can be easier to train and maintain.

Although automatic IP infringement detection and prevention has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-4 maybe modified, and that the foregoing discussion of certain of these embodiments does not necessarily represent a complete description of all possible embodiments. For example, one or more of the procedures, processes, or activities of FIG. 4 mayinclude different procedures, processes, and/or activities and be performed by many different modules, in many different orders. As another example, the modules, elements, and/or systems within system 300 or system 310 in FIG. 3 or used in method 400 in FIG. 4 can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising one or more processors and one or more non-transitory computer-readable media storing computing instructions that, when run on the one or more processors, cause the one or more processors to perform operations comprising:
determining a feature-embedding vector for a listing item based on textual feature data and imagery feature data for the listing item;
determining, via a machine learning module, an intellectual property infringement prediction associated with a genuine item based on a feature-embedding vector for the genuine item and the feature-embedding vector for the listing item; and
upon determining that the intellectual property infringement prediction is positive, causing a take-down of the listing item from a retailer platform.

2. The system in claim 1, wherein the operations further comprise:
training the machine learning module based on a single training dataset comprising respective training items of each intellectual-property-infringed brand of multiple brands.

3. The system in claim 1, wherein:
determining the feature-embedding vector for the listing item further comprises:
extracting one or more textual embeddings from the textual feature data for the listing item;
extracting one or more imagery embeddings from the imagery feature data for the listing item; and
generating the feature-embedding vector for the listing item based on the one or more textual embeddings and the one or more imagery embeddings.

4. The system in claim 1, wherein the operations further comprise:
training the machine learning module based on a training dataset comprising genuine items, positive training items associated with the genuine items, and unlabeled training items.

5. The system in claim 4, wherein:
the unlabeled training items comprise unlabeled intellectual-property-infringing items and unlabeled intellectual-property-noninfringing items.

6. The system in claim 1, wherein the operations further comprise:
sampling, from unlabeled items, unlabeled brand training items of a brand training dataset for an intellectual-property-infringed brand, wherein:
the brand training dataset further comprises genuine brand items for the intellectual-property-infringed brand and positive brand training items associated with the genuine brand items; and
after sampling the unlabeled brand training items, training the machine learning module based at least in part on the brand training dataset.

7. The system in claim 6, wherein:
a quantity of the unlabeled brand training items is proportional to a quantity of the positive brand training items.

8. The system in claim 6, wherein:
the unlabeled brand training items for the intellectual-property-infringed brand comprise respective type items sampled based at least in part on a respective type of each of the respective type items and major item types for the intellectual-property-infringed brand.

9. The system in claim 8, wherein:
the respective type items of the unlabeled brand training items are further sampled based on a respective item-type percentage for each type of the major item types.

10. The system in claim 9, wherein:
the respective type items of the unlabeled brand training items for the intellectual-property-infringed brand are sampled uniformly from each brand of multiple brands for the unlabeled items; and
the multiple brands comprise the intellectual-property-infringed brand.

11. A computer-implemented method comprising:
determining a feature-embedding vector for a listing item based on textual feature data and imagery feature data for the listing item;
determining, via a machine learning module, an intellectual property infringement prediction associated with a genuine item based on a feature-embedding vector for the genuine item and the feature-embedding vector for the listing item; and
upon determining that the intellectual property infringement prediction is positive, causing a take-down of the listing item from a retailer platform.

12. The computer-implemented method in claim 11 further comprising:
training the machine learning module based on a single training dataset comprising respective training items of each intellectual-property-infringed brand of multiple brands.

13. The computer-implemented method in claim 11, wherein:
determining the feature-embedding vector for the listing item further comprises:
extracting one or more textual embeddings from the textual feature data for the listing item;
extracting one or more imagery embeddings from the imagery feature data for the listing item; and
generating the feature-embedding vector for the listing item based on the one or more textual embeddings and the one or more imagery embeddings.

14. The computer-implemented method in claim 11 further comprising:
training the machine learning module based on a training dataset comprising genuine items, positive training items associated with the genuine items, and unlabeled training items.

15. The computer-implemented method in claim 14, wherein:
the unlabeled training items comprise unlabeled intellectual-property-infringing items and unlabeled intellectual-property-noninfringing items.

16. The computer-implemented method in claim 11 further comprising:
sampling, from unlabeled items, unlabeled brand training items of a brand training dataset for an intellectual-property-infringed brand, wherein:
the brand training dataset further comprises genuine brand items for the intellectual-property-infringed brand and positive brand training items associated with the genuine brand items; and
after sampling the unlabeled brand training items, training the machine learning module based at least in part on the brand training dataset.

17. The computer-implemented method in claim 16, wherein:
a quantity of the unlabeled brand training items is proportional to a quantity of the positive brand training items.

18. The computer-implemented method in claim 16, wherein:
the unlabeled brand training items for the intellectual-property-infringed brand comprise respective type items sampled based at least in part on a respective type of each of the respective type items and major item types for the intellectual-property-infringed brand.

19. The computer-implemented method in claim 18, wherein:
the respective type items of the unlabeled brand training items are further sampled based on a respective item-type percentage for each type of the major item types.

20. The computer-implemented method in claim 19, wherein:
the respective type items of the unlabeled brand training items for the intellectual-property-infringed brand are sampled uniformly from each brand of multiple brands for the unlabeled items; and
the multiple brands comprise the intellectual-property-infringed brand.
